(19) United States
(12) Patent Application Publication
(10) Pub. No.: US 2022/0410364 A1
(43) Pub. Date: Dec. 29, 2022

(54) Container for a power tool

(71) Applicant: Hilti Aktiengesellschaft, Schaan (LI)

(72) Inventors: Kenth KARLSSON, Wasserburg (DE); Simon KINDLER, Muenchen (DE); Heiko TULLNEY, Aumuehle (DE)

(21) Appl. No.: 17/898,615

(22) Filed: Aug. 30, 2022

Related U.S. Application Data
(63) Continuation of application No. 16/465,769, filed on May 31, 2019, now abandoned.

(30) Foreign Application Priority Data
Dec. 8, 2016 (EP) 16202809.6

(51) Int. Cl. B25H 3/00; B25H 3/02; B65D 21/02

(52) U.S. Cl. CPC B25H 3/006; B25H 3/02; B65D 21/0204; A45C 7/0045

(57) ABSTRACT

A tool case, especially a carrying case, for storing and transporting a power tool. A shell structure has a shell and a second shell to form a cavity to accommodate the power tool. The first shell has a first side surface and the second shell has a second side surface. A first handle can be reversibly moved around a rotational axis between a first position for carrying the tool case and a second position, whereby the first handle extends in a first plane when in the first position and the first handle extends in a second plane when in the second position, and the first and second planes are arranged orthogonally to each other. A second handle is provided in the area of the first side surface and extends in a third plane and in the second plane, the third plane running parallel to the first plane and to the first side surface.

This is a continuation of U.S. patent application Ser. No. 16/465,769, filed on May 31, 2019 which is a National Phase application of International Patent Application PCT/EP2017/080743, filed on Nov. 29, 2017 which claims priority to European Patent Application EP 16202809.6, filed on Dec. 8, 2016. All of the above referenced applications are hereby incorporated by reference herein.

The present invention relates to a tool case, especially a carrying case, for storing and transporting at least one power tool, comprising a shell structure having a first shell element and a second shell element in order to form a cavity to accommodate the at least one power tool, whereby the first shell element has a first side surface and the second shell element has a second side surface, also comprising a first handle that can be reversibly moved around a rotational axis between a first position for carrying the tool case and a second position, whereby the first handle extends in a first plane when it is in the first position and the first handle extends in a second plane when it is in the second position, and whereby the first and second planes are arranged orthogonally to each other.

### BACKGROUND

Power tools such as, for instance, hammer drills, can be stored and transported in a tool case, especially in the form of a carrying case. Such carrying cases according to the state of the art have a handle at the top of the carrying case. The user can hold and/or carry the carrying case by means of this handle.

A problematic situation is encountered, however, if the user has to simultaneously carry two carrying cases using just one hand. The arrangement or positioning of the handle on a carrying case according to the state of the art only provides inadequate carrying comfort for the user. Moreover, transporting (carrying) two carrying cases according to the state of the art while using just one hand entails an unsafe factor since the carrying case, particularly if it is heavy, can slip out of the user's hand and can fall to the ground. Such a situation can especially arise at a construction site when four power tools are being carried in four individual carrying cases by just one person. If the carrying case accidentally drops from the user's hand and falls to the ground, not only the carrying cases themselves but also the power tools inside the carrying case might be damaged.

### SUMMARY OF THE INVENTION

It is an object of the present invention to provide a tool case, especially a carrying case, for storing and transporting at least one power tool, thus solving the above-mentioned problem and particularly improving the safety when two carrying cases are being transported using just one hand.

The present invention provides a tool case, especially a carrying case, for storing and transporting at least one power tool, comprising a shell structure having a first shell element and a second shell element in order to form a cavity to accommodate the at least one power tool, whereby the first shell element has a first side surface and the second shell element has a second side surface, also comprising a first handle that can be reversibly moved around a rotational axis between a first position for carrying the tool case and a second position, whereby the first handle extends in a first plane when it is in the first position and the first handle extends in a second plane when it is in the second position, and whereby the first and second planes are arranged orthogonally to each other.

According to the invention, there is a second handle in the area of the first side surface and it extends essentially in a third plane as well as in the second plane, whereby the third plane runs essentially parallel to the first plane and to the first side surface. Owing to the inventive configuration and arrangement of the first as well as the second handle, a first tool case and a second tool case can be positioned or connected to each other in such a way that the user can easily grip the second handle of the first tool case as well as the second handle of the second tool case using just one hand. As a result, both carrying cases can be advantageously carried and safely handled relatively comfortably using just one hand.

According to an advantageous embodiment of the present invention, it can be provided for the second handle to have a connecting device on a contact surface so that the contact surface of the second handle of a first tool case can be detachably connected to a contact surface of the second handle of a second tool case. In this manner, a virtually contiguous or tight connection of the two handles can be created, thus reducing the risk of the hand or a finger getting caught between the two second handles of a first and second tool case when both tool cases are picked up and carried.

According to another advantageous embodiment, it can be provided for the connection device to have at least one tongue-and-groove system so that the contact surface of the second handle of the first tool case can be detachably connected to the contact surface of the second handle of the second tool case. This makes it easy to create the connection device in order to detachably connect two tool cases by means of the second handles.

According to an advantageous embodiment of the present invention, it can be provided for at least one information output element to be present in the area of the first and second handles in order to output at least one parameter of a power tool that can be placed in the tool case. In this manner, it is easy to obtain information about the actual contents of the tool case without having to open the tool case. In this context, it is also possible for the information output element to be detachably connected to the tool case, so that one information output element can be replaced by a second information output element. This is particularly advantageous if the contents of the tool case change.

According to another advantageous embodiment, it can be provided for at least one information output element to be present in the area of the first, second, third, fourth, fifth and/or sixth side surfaces in order to output at least one parameter of a power tool that can be placed in the tool case. In this manner, it can be ensured that the information output element can be read from virtually all sides.

According to an advantageous embodiment of the present invention, it can be provided that the information output element contains at least one component of an RFID (radio frequency identification) system or NFC (near field communication) system. This provides a machine-readable or encoded description of the contents of the tool case.

Additional advantages ensue from the figure description below. The figures show various embodiments of the present invention. The figures, the description and the claims contain numerous features in combination. The person skilled in the art will advantageously also consider the features individually and merge them to form additional meaningful combinations.

### BRIEF DESCRIPTION OF THE DRAWINGS

The following is shown:

FIG. 1: a first tool case according to the invention and a second tool case according to the invention, which are connected to each other;

FIG. 2: a side view of a tool case according to the invention, with a second handle;

FIG. 3: a perspective view of the tool case according to the invention, with the second handle;

FIG. 4: another perspective view of the tool case according to the invention, with the first and second handles;

FIG. 5: a view of a third side surface of the tool case according to the invention;

FIG. 6: a detailed view of the first and second handles of a first tool case according to the invention, and a detailed view of the first and second handles of a second tool case according to the invention; and

FIG. 7: another detailed view of the first and second handles of a first tool case according to the invention.

### DETAILED DESCRIPTION

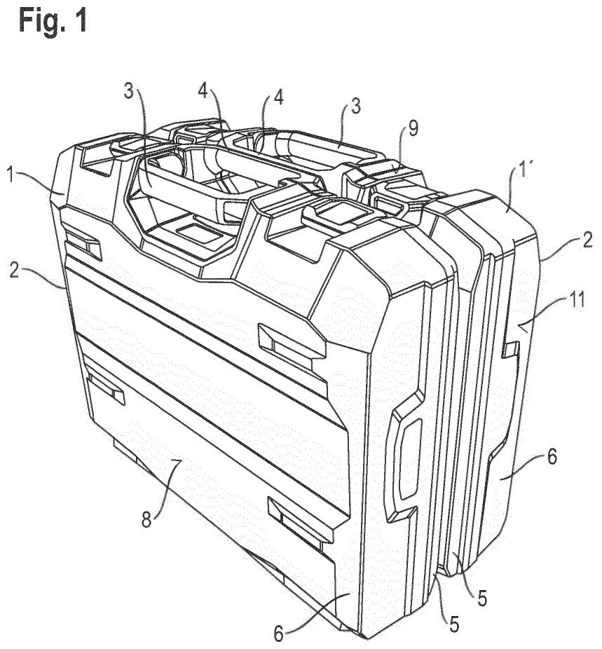

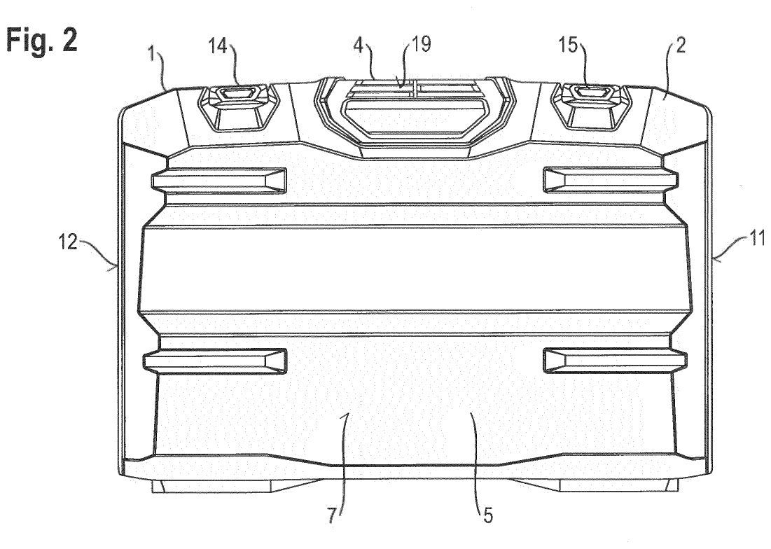

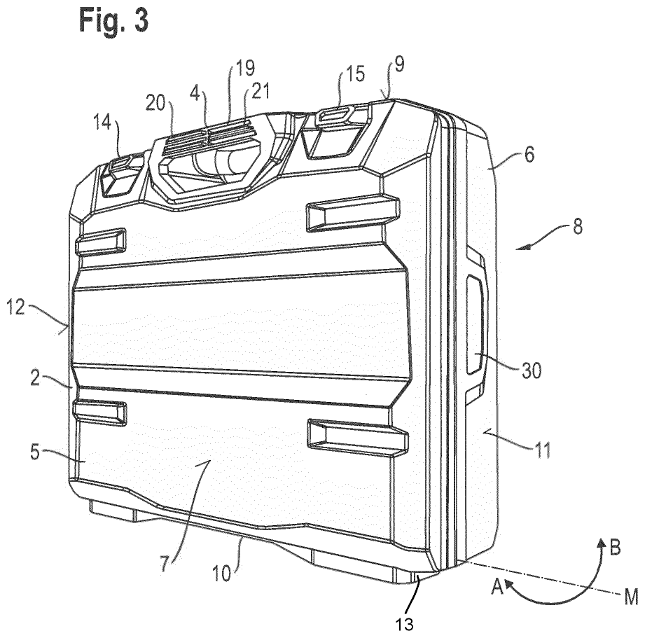

FIGS. 1 to 5 show a tool case 1 in the form of a carrying case for storing and transporting a power tool. The power tool can be a hammer drill or the like. The power tool is not shown in the figures.

The tool case 1, which is configured as a carrying case, essentially has a shell structure 2, a first handle 3 and a second handle 4.

The shell structure 2, in turn, has a first shell element 5 and a second shell element 6. Moreover, the shell structure 2 has a first side surface 7, a second side surface 8, a third side surface 9, a fourth side surface 10, a fifth side surface 11 and a sixth side surface 12.

Here, the first shell element 5 has the first side surface 7 and the second shell element 6 has the second side surface 8.

The first shell element 5 and the second shell element 6 are connected to each other by a hinge means 13 in such a way that the two shell elements 5, 6 can be pivoted around a shared pivot axis M. In this manner, the shell structure 2 or the tool case 1, which is configured as a carrying case, can be opened and closed. For instance, when the carrying case 1 is closed, the two shell elements 5, 6 are in contact with each other, so that a cavity is formed to accommodate the power tool between the two shell elements 5, 6 or inside the shell structure 2. A first closure element 14 and a second closure element 15 are provided on the third side surface 9 in order to secure the closed state of the shell structure 2 or of the tool case 1, which is configured as a carrying case. The first as well as the second closure elements 14, 15 are each configured as a snap-fit closure.

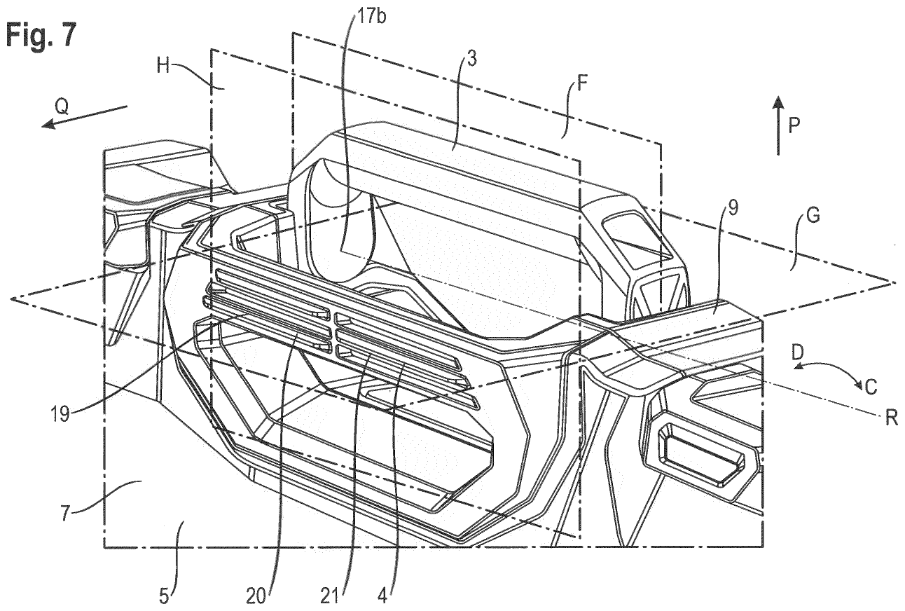

The first handle 3 essentially has a crosspiece 16 that can be reversibly pivoted via a first pivot point 17a and a second pivot point 17b between a first position and a second position around a rotational axis R in the rotating directions C and D. When the crosspiece 16 is in the first position, the crosspiece 16 extends in a first plane F (see FIG. 7). In the first position, the first handle 3 serves to carry the tool case 1, which is configured as a carrying case. As is shown in FIG. 7, the first handle 3 extends beyond the third side surface 9 in the direction P when the first handle 3 is in the first position.

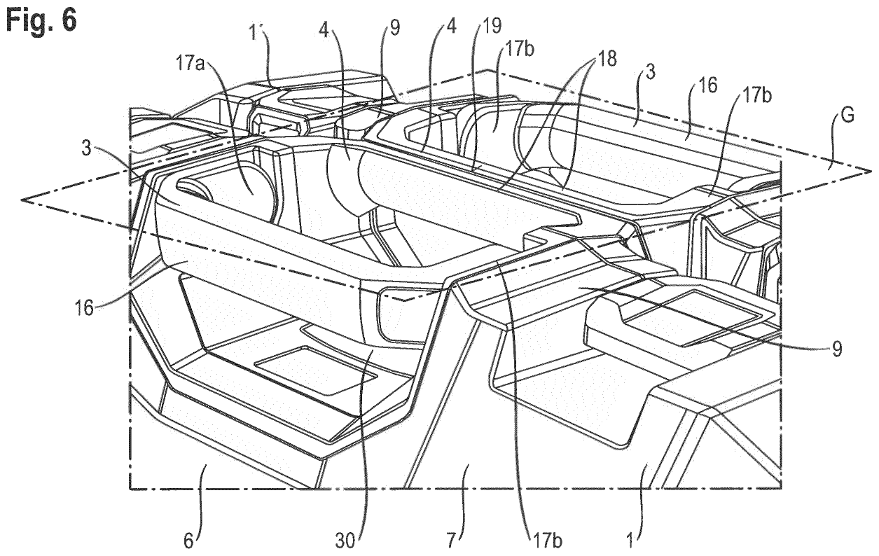

In order for the first handle 3 to be moved from the first position (see FIG. 7) into the second position, the crosspiece 16 is pivoted in the direction C around the rotational axis R by about 90°. In the second position, the crosspiece 16 of the first handle 3 extends into a second plane G (see FIG. 6). In the second position in the second plane G, the crosspiece 16 or the first handle 3 lies flat on the third side surface 9. The first handle 3 has a spring means with a first and a second spring element. The first spring element and the second spring element generate a spring force as a result of which the crosspiece 16 of the first handle 3 is held in the second position. The first handle 3 is moved from the second position into the first position against this spring force of the first and second spring elements. Therefore, the spring force acts in the direction C (see FIG. 7).

The first plane F and the second plane G are arranged orthogonally or at an angle of almost 90° relative to each other.

When the first handle 3 is in the second position, the first handle 3 is positioned in a space-saving manner since it no longer projects away from the third side surface 9 in the direction P.

The second handle 4 is provided in the area of the first side surface 7 and it is firmly connected to the first shell element 5 in the upper area (in the direction P). As can be seen especially in FIG. 6, the second handle 4 essentially has a crosspiece-shaped grip section 18 with a contact surface 19. The second handle 4 extends essentially in a third plane H as well as in the second plane G. In this context, the third plane H runs parallel to the first plane F and to the first side surface 7. Therefore, the crosspiece-shaped grip section 18 extends in the direction P in the third plane H as well as in the direction Q in the second plane G. Consequently, the second handle 4 can be seen as a handle extending in the direction Q as well as in the direction P.

The contact surface 19 of the second handle 4, in turn, has a connecting device 20 so that the contact surface 19 of the second handle 4 of a first tool case 1 can be detachably connected to the contact surface 19 of the second handle 4 of a second tool case 1′.

The connection device 20 has a tongue-and-groove system 21 so that the contact surface 19 of the second handle 4 of the first tool case 1 can be detachably connected to a contact surface 19 of a second handle 4 of a second tool case 1′ (see FIGS. 1 and 6). For this purpose, the tongue of the contact surface 19 of the second handle 4 of the first tool case 1 is inserted in a familiar manner into a groove of the contact surface 19 of the second handle 4 of the second tool case 1′. The contact surface 19 of the second handle 4 of the first tool case 1 is thus non-positively connected to the contact surface 19 of the second handle 4 of the second tool case 1′.

When the contact surfaces 19 of the second handle 4 of the first tool case 1 are connected to the contact surface 19 of the second handle 4 of the second tool case 1′, the second handle 4 of the first tool case 1 and the second handle 4 of the second tool case 1′ form a shared handle for the first as well as for the second tool case 1, 1′ together. A user can grip the shared handle with one hand in order to thus comfortably and safely pick up the first and second tool cases 1, 1′. As can be seen in FIGS. 1 and 6, the first handle 3 of the first tool case 1 and the first handle 3 of the second tool case 1′ are each flipped open and are in the second position in a space-saving manner when the second handle 4 of the first tool case 1 and the second handle 4 of the second tool case 1′ are connected to the appertaining contact surfaces 19 and form the shared handle.

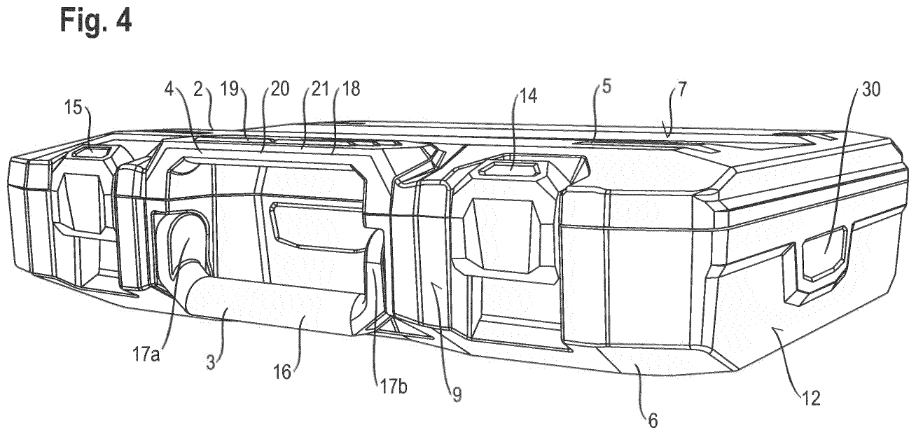

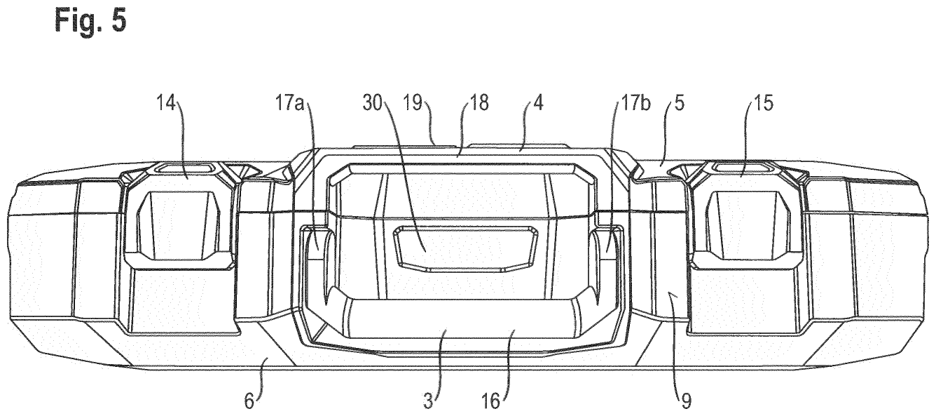

Moreover, in the area of the first and second handles 3, 4 of the tool case 1, there is an information output element 30 to output at least one parameter of a power tool that can be placed in the tool case 1; see FIGS. 4 and 5. In the present embodiment, the information output element 30 is provided with a schematic depiction of the power tool, with the type designation of the power tool as well as with the name of the manufacturer. In addition, the information output element 30 also has a two-dimensional code (2D code) in the form of a data matrix code. According to another embodiment, the information output element 30 can also be configured with an RFID system and/or NFC system.

The information output element 30 in the present embodiment is positioned on the third side surface 9, on the fifth side surface 11 and on the sixth side surface 12. However, it is likewise possible for the information output element 30 to be positioned on every side surface 7 to 12.

1. A combined tool case system for storing and transporting power tools, the tool case system comprising:
a first tool case comprising:
a shell structure having a first shell element and a second shell element in order to form a cavity to accommodate the at least one power tool, the first shell element having a first side surface and the second shell element having a second side surface;
a first handle reversibly movable around a rotational axis between a first position for carrying the tool case and a second position, the first handle extending in a first plane when in the first position and the first handle extending in a second plane when in the second position, and the first and second planes arranged orthogonally to each other; and
a second handle in an area of the first side surface and extending in a third plane as well as in the second plane, the third plane running parallel to the first plane and to the first side surface; and
a second tool case having a second case first handle and a second case second handle;
wherein the second handle has a connector on a contact surface so that a contact surface of the second handle of the tool case is detachably connectable to a further contact surface of the second case second handle.

2. The combined tool case system as recited in claim 1 wherein the connector has at least one tongue-and-groove system.

3. The combined tool case system as recited in claim 1 further comprising at least one information output element present in the area of the first and second handles in order to output at least one parameter of a power tool placeable in the tool case.

4. The combine tool case system as recited in claim 3 wherein the information output element contains at least one component of an RFID system or NFC system.

5. The combined tool case system as recited in claim 1 further comprising at least one information output element present in the area of the first or second side surfaces or of a third, fourth, fifth or sixth side surface in order to output at least one parameter of a power tool placable in the tool case.

6. The combined tool case system as recited in claim 5 wherein the information output element contains at least one component of an RFID system or NFC system.

7. The combined tool case system as recited in claim 1 wherein the first shell element and the second shell element are connected to each other by a hinge and pivotable around a shared pivot axis.

8. The combined tool case system as recited in claim 1 wherein the shell structure defines the first side surface, the second side surface, a third side surface, a fourth side surface, a fifth side surface and a sixth side surface.

9. The combined tool case system as recited in claim 8 further comprising a first closure and a second closure provided on the third side surface in order to secure a closed state of the shell structure.

10. The combined tool case system as recited in claim 9 wherein the first and the second closures are snap-fit closures.

11. The combined tool case system as recited in claim 1 wherein the first handle has a crosspiece reversibly pivotable via a first pivot point and a second pivot point between the first position and the second position around a rotational axis.

12. The combined tool case system as recited in claim 1 wherein the first handle extends beyond the third side surface when the first handle is in the first position.

13. The combined tool case system as recited in claim 12 wherein when the first handle is in the second position, the first handle no longer projects away from the third side surface.

14. The combined tool case system as recited in claim 1 wherein the second handle and the second case second handle are connected at the contact surface and the further contact surface, the first handle is in the second position.

15. The combined tool case system as recited in claim 1 wherein the second handle and the second case second handle are connected at the contact surface and the further contact surface, the first handle and the second case first handle lie in the second plane.
